(19) United States
(12) Patent Application Publication
(10) Pub. No.: US 2024/0359677 A1
(43) Pub. Date: Oct. 31, 2024

(54) SPRING-LOADED BRAKE ACTUATOR

(71) Applicant: Hanning & Kahl GmbH & Co, KG, Oerlinghausen (DE)

(72) Inventor: Björn Christian SUREN, Oerlinghausen (DE)

(21) Appl. No.: 18/625,498

(22) Filed: Apr. 3, 2024

(30) Foreign Application Priority Data
Apr. 28, 2023 (DE) 202023102323.1

(51) Int. Cl. B60T 17/08

(52) U.S. Cl. CPC B60T 17/086; B60T 17/083

(57) ABSTRACT

A spring-loaded brake actuator includes a push rod that can be coupled to a braking element of a brake, an energy accumulator which is designed to apply a braking force onto the push rod via a coupling mechanism, a drive, which is designed to hold the push rod in a brake release position against the force of the energy accumulator, and an auxiliary release device, with which the transmission of the braking force from the energy accumulator to the push rod can be blocked independently of the drive, in which the coupling mechanism has two coupling members which are in engagement with one another via a claw clutch, and in that the auxiliary release device has an actuating element which is designed to bring the claws of the claw clutch into a non-engaged position in a direction of movement transverse to the force transmission direction.

The invention relates to a spring-loaded brake actuator with a push rod that can be coupled to a braking element of a brake, an energy accumulator that is set up to exert a braking force on the push rod via a coupling mechanism, and a drive that is set up to hold the push rod in a brake release position against the force of the energy storage device, and an auxiliary release device with which the transmission of the braking force from the energy storage device to the push rod can be blocked independently of the drive.

In order for the brakes of a rail vehicle to remain functional even if the energy supply fails completely, the wheel brakes are usually designed as spring-loaded brakes, in which the braking force is provided by an energy accumulator that is formed, for example, by a disc spring column. A hydraulic drive is used to hold the brake in the release position. A braking operation can then be triggered simply by deactivating the drive.

In the event of a power supply failure, the drive is ineffective, so the brakes are inevitably activated. However, since in such a situation there may be a need to release the brakes and move the vehicle, such spring brakes have an auxiliary release device that allows the brake to be released by hand.

DE 29 70 858 U1 describes a spring-loaded brake in which the auxiliary release device is formed by an auxiliary piston that is part of the hydraulic drive and can be pressurized via a hand-operated pump in order to release the brake against the force of the disc spring package.

The force transmission element with which the braking force is transmitted to the brake shoes or a floating caliper of a brake is usually formed by a push rod, which acts on the brake caliper either directly or via a deflection lever. The power transmission mechanism usually also contains a so-called adjuster, with which the air clearance of the brake can be automatically adjusted if this clearance has changed due to wear on the brake pads. In such an adjuster, a rotary movement is usually converted into an axial movement via a spindle mechanism. This mechanism can also form an auxiliary release device with which a torque exerted manually onto the spindle can be converted with a high amplification factor into an axial force in order to cancel the force of the spring accumulator. The disadvantage, however, is that the operation of such an auxiliary release device is relatively complicated and time-consuming and that the clearance must be reset again after an auxiliary release process.

For brakes in which the push rod acts on the brake caliper via a deflection lever, auxiliary release devices are also conceivable, with which the flow of force from the spring accumulator to the brake is interrupted at the deflection lever.

The object of the invention is to create a spring-loaded brake actuator with an easy-to-use auxiliary release device that can also be used in coupling mechanisms without a deflection lever.

This object is achieved according to the invention in that the coupling mechanism has two coupling members which are in engagement with one another via a claw clutch, and in that the auxiliary release device has an actuating element which is designed to move the claws of the claw clutch in a direction of movement transverse to the force transmission direction into a non-engagement position.

According to the invention, the power flow between the energy accumulator and the braking element is simply interrupted by releasing the claw clutch. Since the release movement of the claws is perpendicular to the direction of force transmission, the force of the energy accumulator does not need to be overcome during the release process, so that the brake can be released manually with little effort. In order to bring the claw clutch back into engagement after an emergency release process, when the drive of the brake actuator is ready for operation again, it is sufficient to activate the drive once in order to compress the spring package of the energy accumulator to such an extent that the claw clutch automatically engages again.

Advantageous refinements and further developments of the invention are specified in the subclaims.

An exemplary embodiment is explained in more detail below by reference to the drawings, wherein:

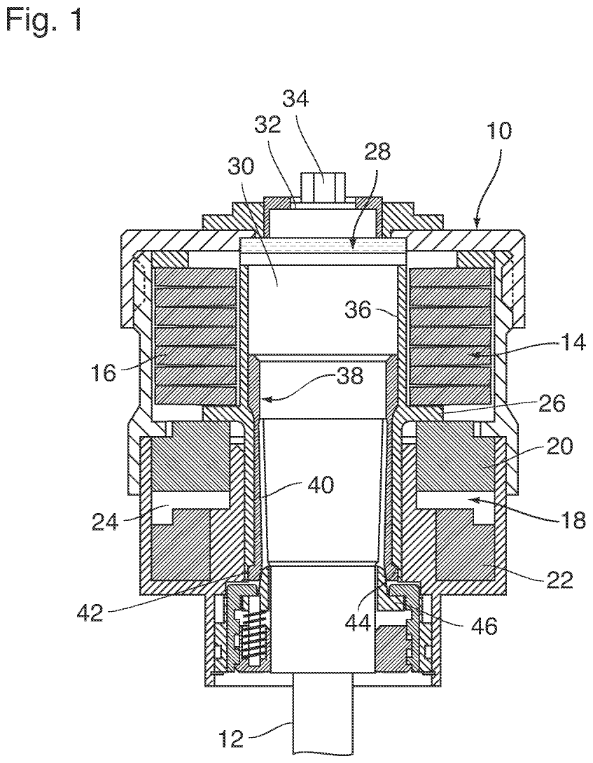

FIG. 1 shows an axial section through a brake actuator according to the invention in a brake release position;

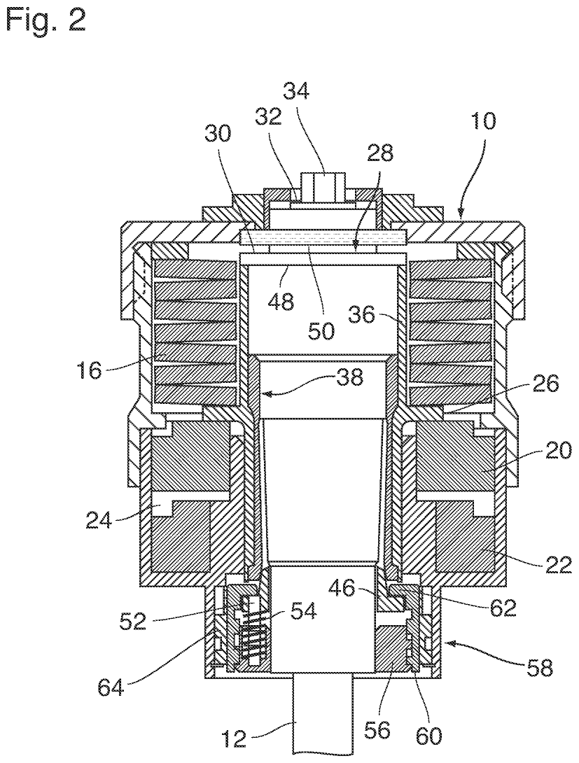

FIG. 2 shows the brake actuator according to FIG. 1 in a braking position;

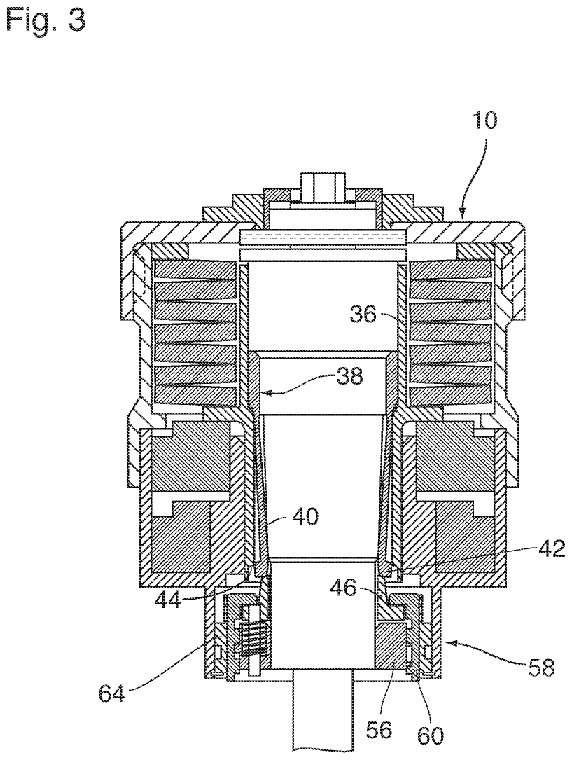

FIG. 3 shows the brake actuator in a state in which the auxiliary release device is actuated;

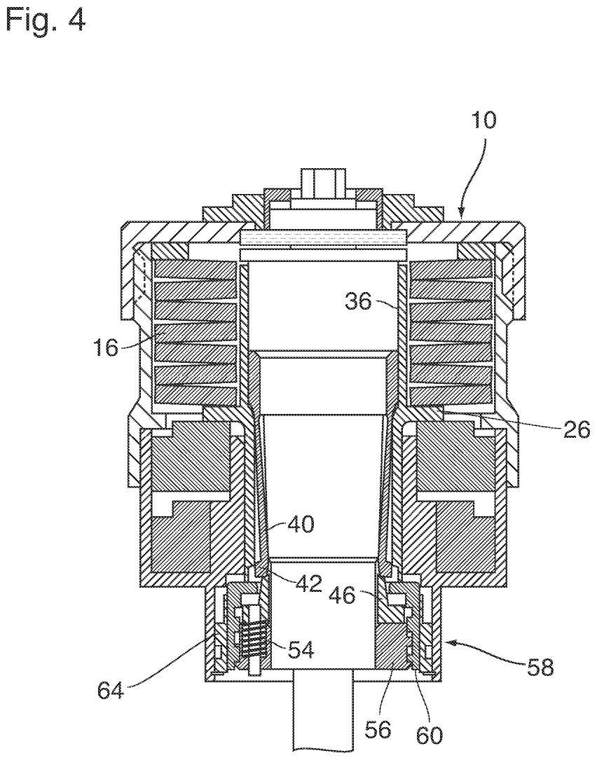

FIG. 4 shows the brake actuator in a state in which the auxiliary release device is not actuated but the brake is not yet ready for operation again; and

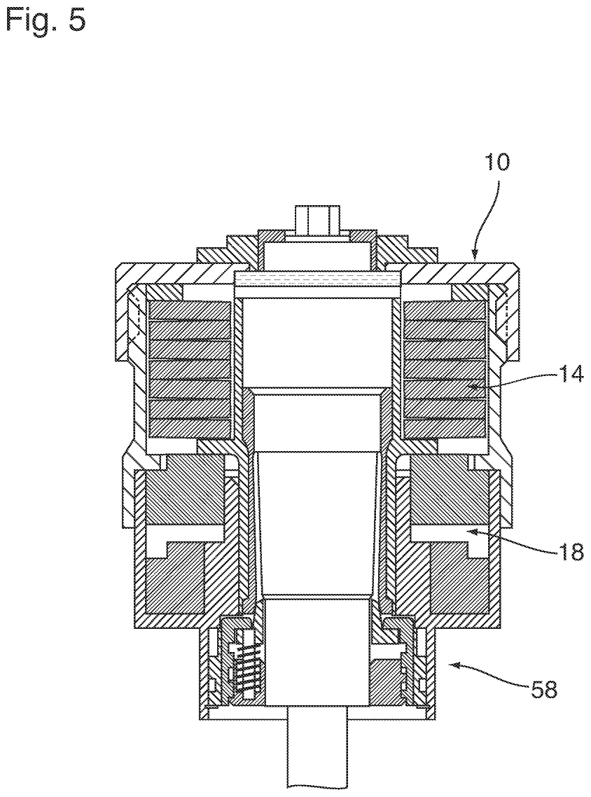

FIG. 5 shows the brake actuator in the operational state again.

The brake actuator shown in FIG. 1 has a housing 10 composed of several parts, from which a force transmission element in the form of a push rod 12, which can be coupled either directly or indirectly via a deflection lever to a braking element of a brake of a rail vehicle, emerges at the lower end in FIG. 1. The upper part of the housing 10 accommodates an energy accumulator 14, which is formed by a column or a package of disc springs 16 stacked one on top of the other. In the lower part, the housing 10 accommodates a hydraulic drive 18, which has a main pressure chamber 24 delimited by a main piston 20 and an auxiliary piston 22.

In the state shown in FIG. 1, the main pressure chamber 24 is pressurized so that the main piston 20 is pressed upwards against a spring plate 26, on which the energy accumulator 14 is supported with its lower end. The disc spring package of the energy accumulator 14 is thereby compressed between the spring plate 26 and an upper wall of the housing 10. The spring plate 26 is also part of a coupling mechanism with which the force of the energy accumulator 14 can be transmitted to the push rod 12. Another part of the coupling mechanism is an adjuster 28, which is used to automatically adjust the clearance of the brake and of which can be seen only an essentially cylindrical, but downwardly tapering adjuster housing 30 and an end of a spindle 32 protruding from the adjuster housing and carrying a hexagon head 34 protruding from the housing 10. The internal structure and functionality of the adjuster 28 are known as such and are therefore not described in more detail here.

The adjuster housing 30 is surrounded by a sleeve 36, which is formed in one piece with the spring plate 26 and projects axially both upwards and downwards from the inner peripheral edge of the spring plate 26. In addition to the spring plate 26 and the adjuster 28, the coupling mechanism also includes a claw clutch 38, which annularly surrounds the adjuster housing 30 and creates a detachable form-fitting connection between the spring plate 26 and the adjuster housing 30. For this purpose, an annular upper part of the claw clutch 38 is rigidly connected to the adjuster housing 30, while a lower part of the claw clutch is formed by a ring of elastic fingers 40, which extend axially from the annular upper part and each of which carries on the lower end a claw 42 that is bent outwards. In the state shown in FIG. 1, these claws grip under a shoulder 44 formed at the lower end of the sleeve 36.

If the brake is to be actuated, the main pressure chamber 24 is depressurized so that the main piston 20 and the spring plate 26 move downwards under the force of the disc springs 16 into the position shown in FIG. 2. The force of the disc springs 16 acts on the claws 42 via the shoulder 44, so that the claw clutch 38 and thus also the adjuster 28 and the push rod 12 are pulled downwards. The brake is actuated by this axial movement of the push rod 12. The force of the energy accumulator 14 is transmitted via the spring plate 26, the claw clutch 38, the adjuster 28 and the push rod 12 to the braking element, for example a brake pad, so that the brake pad is pressed firmly against a brake disc and thus generates a high friction braking force. The claws 42 and the free ends of the 5 fingers 40 are held in a radially outwardly flared position by an expansion cone 46 entering the ring of the fingers 40 from below, so that the claws 42 do not slip off the shoulder 44.

In FIG. 2 it can be seen that, compared to FIG. 1, the distance between the main piston 20 and the auxiliary piston 22 has decreased because the main piston 20 and the spring plate 26 have moved downwards. Furthermore, it can be seen that due to the downward movement of the adjuster 28, a gap has formed between a flange 48 at the upper end of the adjuster housing 30 and a closing element 50 held firmly in the housing 10.

If the brake is to be released again, hydraulic fluid is pumped into the main pressure chamber 24 using an electrically driven pump, so that the main piston 20 is pressed upwards again against the force of the disc springs 16. This means that the shoulder 44 no longer exerts any axial force on the claws 42 and thus the pressure rod 12 and the braking element of the brake are relieved. Since the spring plate 26 is pressed upwards by the main piston 20, the sleeve 36 abuts with its upper edge on the flange 48 of the adjuster housing, so that the adjuster 28 and the push rod 12 return to the position shown in FIG. 1.

The expansion cone 46 is axially displaceably guided on pins 52 and is axially biased against the fingers 40 of the claw clutch 38 by springs 54 which surround the pins 52, so that the claws 42 are held in engagement on the shoulder 44. The lower ends of the springs 54 are supported on a ring 56 which is rigidly connected to the tapered lower end of the adjuster housing 30.

If the main pressure chamber 24 can no longer be pressurized in the event of a failure of the energy supply or a failure of the hydraulic pump, the brake actuator would remain in the state shown in FIG. 2 and the brake would be constantly active, so that the vehicle could not be moved. In order for the brake to be released in such a case, there are various ways to release the brake by hand. One of these possibilities is that the underside of the auxiliary piston 22 is pressurized with a manually operated pump, so that the auxiliary piston 22 is displaced against the main piston 20 and then presses the spring plate 26 upwards against the force of the plate springs 16. However, this process is time-consuming because a relatively high hydraulic pressure must be built up with the hand-operated pump. Another possibility is to use a tool to rotate the hexagon head 34 and thus the spindle 32 and thereby adjust the axial position of the push rod 12 relative to the adjuster housing 30, so that the spring plate 26 and the adjuster housing 30 remain in the lowered position but the push rod 12 is pulled upwards and the brake is thus released. However, this option has the disadvantage that after such a release process, the clearance of the brake has to be laboriously readjusted again, for example by pressing and releasing the brake several times with the help of the main piston 20.

According to the invention, the brake actuator shown here has an additional auxiliary release device 58, the structure of which will now be explained with reference to FIG. 2.

The ring 56 engages on its outer circumference via a steep thread with a bushing 60, which, at its upper end, straddles a flange of the expansion cone 46 with a flange 62. A cable drum 64 is held rotatably and axially fixed in the lower part of the housing 10 and is in engagement with the bushing 60 in such a way that the bushing 60 is axially displaceable, but rotates with this cable drum when the cable drum rotates. A pull cable, not shown here, is wound onto the cable drum. If a pull is exerted on this pull cable by hand, for example via a lever, the cable drum 64 and the bushing 60 are set into rotation. Due to the steep thread, the bushing 60 moves downwards relative to the ring 56, so that the expansion cone 46 is pulled downwards against the force of the springs 54. This allows the claws 42 to pivot inwardly and clear of the shoulder 44 of the sleeve 36, as shown in FIG. 3. The inward pivoting movement of the fingers 40 can be caused by these fingers being elastically biased into the radially inner position and/or by the shoulder 44 and the claws 42 being slightly bevelled.

In the state shown in FIG. 3, the flow of force between the spring plate 26 and the claw clutch 38 is interrupted, so that the adjuster 28 and the push rod 12 are no longer held in the brake actuation position and therefore no longer exert any force on the braking element. Due to a certain inherent elasticity of the braking element, the push rod 12 and the adjuster 28 will move somewhat towards the brake release position shown in FIG. 1.

When no more tension is exerted on the cable drum 64 via the cable, it returns to its starting position under the action of a return spring, not shown, so that the bushing 60 is pushed upwards again into the position shown in FIG. 4. However, the expansion cone 46 still remains in the lowered position because its upper end abuts the claws 42 and these are prevented from pivoting outwards again by the sleeve 36, which is still held in the lowered position.

When the drive 18 is ready for operation again, the main piston 20 can be moved hydraulically again into the raised position, as shown in FIG. 5. The disc springs 16 are compressed, and the spring plate 26 and the sleeve 36 are raised to such an extent that the expansion cone 46 runs onto the fingers 40 under the force of the springs 54 and pushes the claws 42 outwards again, so that they click into place on the shoulder 44. Since the clearance of the brake was not adjusted during the processes described in FIGS. 3 to 5, the brake is then immediately ready for operation again.

What is claimed is:

1. A spring-loaded brake actuator comprising:
a push rod adapted to be coupled to a braking element of a brake,
a coupling mechanism,
an energy accumulator configured to apply a braking force onto the push rod via the coupling mechanism,
a drive configured to hold the push rod in a brake release position against the force of the energy accumulator, and
an auxiliary release device, with which the transmission of the braking force from the energy accumulator to the push rod can is adapted to be blocked independently of the drive,
wherein the coupling mechanism has two coupling members which are in engagement with one another via a claw clutch, and
wherein the auxiliary release device has an actuating element which is designed to bring claws of the claw clutch into a non-engaged position in a direction of movement transverse to the force transmission direction.

2. The brake actuator according to claim 1, wherein the energy accumulator has a spring system, and one of the coupling members is a spring plate.

3. The brake actuator according to claim 2, wherein another of the coupling members is an adjuster for adjusting the clearance of the brake.

4. The brake actuator according to claim 3,
wherein the claw clutch has an annular part which is rigidly connected to an adjuster housing of the adjuster and from which a plurality of elastic fingers extend axially, each carrying a claw at a free end thereof, and
wherein the spring plate is rigidly connected to a sleeve which surrounds the adjuster housing and the claw clutch and has, on an inner circumference thereof, a shoulder, at which the claws are adapted to snap into place.

5. The brake actuator according to claim 4, wherein the auxiliary release device has an expansion cone which holds the claws in engagement on the shoulder in the operational state of the brake actuator and which is retractable by the actuating element in axial direction relative to the claws to release the claws.

6. The brake actuator according to claim 5, wherein the auxiliary release device has a cable drum for a pull cable, the drum being connected to the actuating element via a gear transmission.

7. The brake actuator according to claim 6, wherein the actuating element is a bushing which:
engages:
via a steep thread thereof with a ring held rigidly on the adjuster housing and
via a flange of the expansion cone with a flange thereof and
is axially displaceable and non-rotatably connected to the cable drum.
